(19) United States
(12) Patent Application Publication
(10) Pub. No.: US 2018/0237287 A1
(43) Pub. Date: Aug. 23, 2018

(54) METHOD AND APPARATUS FOR TRANSFERRING FLUIDS

(71) Applicant: Merrill Solomon, Potomac, MD (US)

(72) Inventor: Merrill Solomon, Potomac, MD (US)

(21) Appl. No.: 15/897,635

(22) Filed: Feb. 15, 2018

Related U.S. Application Data
(60) Provisional application No. 62/460,135, filed on Feb. 17, 2017.

(51) Int. Cl. B67D 7/02; B67C 9/00

(52) U.S. Cl. CPC B67D 7/0288; B67D 2210/0016; B67C 9/00

(57) ABSTRACT

A method and device for transferring viscous fluid between bottles includes an upper section for receiving and engaging a first bottle to be emptied in an inverted orientation, and a lower section having a polyhedral prism exterior profile of smaller transverse section adapted to be received and engaged in the neck of a second bottle to receive the viscous fluid. An air flow exhaust path is provided between the upper section and the second bottle. A plurality of air passages conduct displaced air from the interior of the second bottle to the exhaust path, each configured with a circular segment cross-section defined between a respective face of the polyhedral prism and a respective arcuate section of the neck of the second bottle facing and spaced from that face. The upper and lower sections are configured to engage differently sized and configured bottle necks.

### CROSS REFERENCE TO RELATED APPLICATIONS

The present application claims priority from and is a non-provisional application of U.S. Provisional Application No. 64/460,135 entitled “Device for Transferring Fluids”, filed Feb. 17, 2017, the disclosure of which is hereby incorporated by reference in its entirety.

### BACKGROUND

### Technical Field

The present invention pertains to methods and apparatus for enabling transfer of viscous fluid from an almost empty container to another container.

### Discussion of the Prior Art

For bottles that incorporate a hand-actuated vacuum pump to dispense a fluid, particularly a relatively high viscous fluid such as cosmetic creams, body lotions, etc., it is difficult to dispense and use remaining amounts of the fluid as the bottle contents approach empty. This is partly because of the shape of substantially the mass produced blow-molded plastic bottles that are used as containers for the creams and lotions, and also the inherent deficiencies in the design of the vacuum pumps that are used to dispense those creams and lotions. Consumer annoyance created by the significant amount of lotion/cream left at the bottom of a “not so empty” bottle resulted in both Consumer Reports and the Wall Street Journal publishing separate fairly detailed investigative studies, both of which came to the same conclusion, namely that between 17% to 25% of the total amount of the creams and lotions in those bottles is inaccessible to, and cannot be dispensed by, the provided hand pump. As a result, that remnant amount of purchased cream/lotion is usually thrown away with the bottle.

The reason for the consumer annoyance created by this inaccessible and typically “thrown away” amount of lotion or cream may be described in one or more of three ways:
1. Many times the fluid is an expensive dermatologic cream, or high end cosmetic product, and, therefore, discarding 25% of that costly fluid causes purchasers to feel that they are just throwing away money;
2. To many purchasers, discarding that much lotion unnecessarily creates a negative environmental impact; and, lastly,
3. Many people believe that big companies purposely sell products that “rob them” of 25% of the product they pay for, i.e., the companies are unfairly taking advantage of them.
   As a consequence, many consumers attempt to find a way to recover and use the remnant amount of the product that they purchased by either: (a) somehow cutting open the plastic bottles and in one way or another scooping out by hand the remnant cream or lotion; or (b) trying products that are touted as being able to recover the bottom-remaining lotion by transferring the fluid from one bottle to another. In the latter case, the thusly touted products do not work as advertised for reasons stated below.

Cutting open a plastic bottle is cumbersome, potentially dangerous, and does not really solve the problem of making the lotion easy to access. Moreover, once exposed to air when the bottle is cut open, many creams and lotions tend to solidify or “cake” and become unusable for their intended purposes.

As for the touted devices, they do not effectively accomplish the task of recovering the un-extractable lotion because they typically do not properly take the requirement for air displacement into consideration. Specifically, air occupies the empty volume in the receiving bottle and must somehow be permitted to egress from that bottle in order for the incoming lotion or cream fluid to flow in. Attempts to address this issue have been largely unsuccessful because the path or passage provided for egressing air is too restricted. For example, U.S. Pat. No. 3,877,499 (Fluster) discloses a device having a funnel for supporting an inverted bottle to be emptied, and a collar that is received and supported on the neck of the bottle to be filled. Narrow longitudinally extending channels are defined in the inner wall of the collar and funnel for the intended purpose of permitting air to escape from the bottle to be filled as the cream or lotion flows in from the inverted bottle. However, the total cross-sectional area provided by these channels is quite small, with the result air does not freely escape causing the flow of lotion or cream to be much too slow to be acceptable. Attempts by the consumer to speed up the flow by squeezing the inverted bottle being emptied tends to force the lotion or cream back up and around the inverted bottle and out of the funnel. Other devices provide intended air flow egress passages as a thin annular space between the inverted bottle and the funnel, or as a loose threaded engagement between the flow transfer device and the receiving bottle, but, again, the total cross-sectional area provided for the flow is too restrictive to permit lotion or cream flow rates that are acceptable for most practical purposes.

As a separate issue, in order to be commercially acceptable, a device for facilitating transfer of fluids such as lotions and liquids from one bottle to another should be capable of accommodating most if not all of the various sizes and configurations of necks of bottles on the market for both bottles. Apart from simply accommodating the different bottle neck sizes and configurations, the device must do so while providing positional stability for both bottles so that the fluid transfer can be effected without the bottles becoming inadvertently dissociated from each other and the device if not held by the user.

### Terminology

It is to be understood that, unless otherwise stated or contextually evident, as used herein:

The terms “upper”, “top”, “lower”, “bottom”, “vertical”, “horizontal”, etc., are used for convenience to refer to the orientation of a fluid transfer device of the present invention when attached to two containers to effect a fluid transfer and are not intended to otherwise limit the structures described and claimed.

The terms “axial”, “longitudinal”, etc., refer to dimensions extending parallel to the longitudinal flow axis of the fluid transfer device of the present invention.

The terms “radial”, “lateral”, “transverse”, etc., refer to dimensions extending perpendicularly from the central longitudinal axis of the fluid transfer device of the present invention.

The terms “angle”, “angular”, “rotationally”, etc., unless otherwise stated refer to the rotation dimension about the central longitudinal axis.

The term “fluid” as used herein refers non-gaseous flowable fluids, particularly fluids having a high viscosity (typically, but without limitation, in the range of 1,000 to 200,000 centipoise) such as, for example, cosmetic creams and lotions.

The term “bottle” as used herein refers to containers, typically made of plastic (but possibly glass or metal) with a narrow neck for containing non-gaseous viscous fluid such as cosmetic and body creams and lotions. The terms “bottle” and “container” are used interchangeably herein.

### OBJECTS AND SUMMARY OF THE INVENTION

Therefore, in light of the above, and for other reasons that become apparent when the invention is fully described, it is an object of the present invention to provide methods and apparatus for more efficiently and effectively transferring viscous fluid from a nearly empty container to another container.

More specifically, it is an object of the invention to provide a flow transfer device for viscous fluid that is inexpensive to manufacture, that works with substantially all brands and bottle sizes, and that permits extraction of all, or substantially all, of the residual and otherwise non-recoverable lotion and/or cream that remains at the bottom of an almost empty lotion bottle by efficiently transferring that residual lotion/cream into and through the top of a receiving bottle.

The essence of the invention is two-fold: (1) providing a device enabling free gravitationally induced flow of the residual or remnant volume of creams/lotions from an almost empty inverted bottle into a receiving bottle by providing an efficient egress passageway for air being displaced from the receiving bottle; and (2) configuring that device to accommodate bottle mouths of substantially any size with positional stability.

Briefly, a disclosed embodiment of the present invention comprises a fluid transfer device having an upper section for receiving the neck of an inverted bottle, and a lower flow tube section configured to be extended into the neck of a receiving bottle. The hollow upper section has an open top and a bottom wall having an upward facing interior surface, a downward facing exterior surface and a flow transfer aperture defined therethrough. The lower flow tube section has an external profile in the form of a polyhedral prism (e.g., a triangular prism) extending longitudinally downward from the downward facing exterior surface of the upper section bottom wall. The lower section has an interior flow passage extending longitudinally therethrough along a longitudinal flow axis of the tube and aligned in flow communication with the flow transfer aperture in the upper section bottom wall. At least one spacer projects downward from the upper section.

The open upper section is configured to receive and engage the neck of an inverted bottle to be emptied. The lower section id configured to extend through the neck of the receiving bottle. The spacer and is configured to provide an air flow exhaust space between the upper section bottom wall and the lip of the receiving bottle in which the lower section is received. Each exterior longitudinal edge of the lower section contacts the inner wall of the neck of the bottle in which it is received to provide a firm and stable contact or engagement between the lower section and the receiving container. The flat faces of the polyhedral lower section define relatively wide parallel air flow passages with the opposing sections of the cylindrical neck of the receiving bottle. These passages are in flow communication with the air flow exhaust space to permit unrestricted egress of displaced air from the container being filled.

The longitudinal edges of the lower section may be provided with radial extension variations along their length to permit close fit contact with container necks of different sizes. The upper section interior may be suitably threaded and otherwise contoured, and its annular top edge may be provided with notches, all to accommodate and stably engage differently configured container necks.

The invention also comprises a method for transferring viscous fluids from one bottle to another by supporting an inverted bottle to be emptied above and in axial alignment with a bottle to be filled and gravitationally flowing the fluid through a flow tube that extends into the bottle to be filled. Stable three-edge contact is provided between the flow tube and the cylindrical interior wall of the neck of the bottle to be filled. Wide air egress passages having transverse cross sections in the form of circular segments assure free displacement of air in the bottle to be filled. Universal engagement is provided for bottles with different neck sizes and/or configurations.

The above and still further features and advantages of the present invention will become apparent upon consideration of the definitions, descriptions and descriptive figures of specific embodiments thereof set forth herein. In the detailed description below, like reference numerals in the various figures are utilized to designate like components and elements, and like terms are used to refer to similar or corresponding elements in the several embodiments. While these descriptions go into specific details of the invention, it should be understood that variations may and do exist and would be apparent to those skilled in the art in view of the following description.

### BRIEF DESCRIPTION OF THE DRAWINGS

FIG. 1 is a front right perspective view from above of a fluid transfer device according to one embodiment of the present invention.

FIG. 2 is a front right perspective view from below of the fluid transfer device of FIG. 1.

FIG. 3 is a front left perspective view from above of the fluid transfer device of FIG. 1.

FIG. 4 is a front left perspective view from below of the fluid transfer device of FIG. 1.

FIG. 5 is a top perspective view of the fluid transfer device of FIG. 1.

FIG. 6 is a bottom perspective view of the fluid transfer device of FIG. 1.

FIG. 7 is a front view in elevation of the fluid transfer device of FIG. 1.

FIG. 8 is a rear view in elevation of the fluid transfer device of FIG. 1.

FIG. 9 is a left side view in elevation of the fluid transfer device of FIG. 1.

FIG. 10 is a right side view in elevation of the fluid transfer device of FIG. 1.

FIG. 11 is a top view in plan of the fluid transfer device of FIG. 1.

FIG. 12 is a bottom view in plan of the fluid transfer device of FIG. 1.

FIG. 13 is an exploded view illustrating diagrammatically how the device of FIG. 1 may be connected to a supply bottle to be emptied.

FIG. 14 is a view in elevation and partial section showing diagrammatically how the device of FIG. 1 connects to and functions with a supply bottle and a receiving bottle.

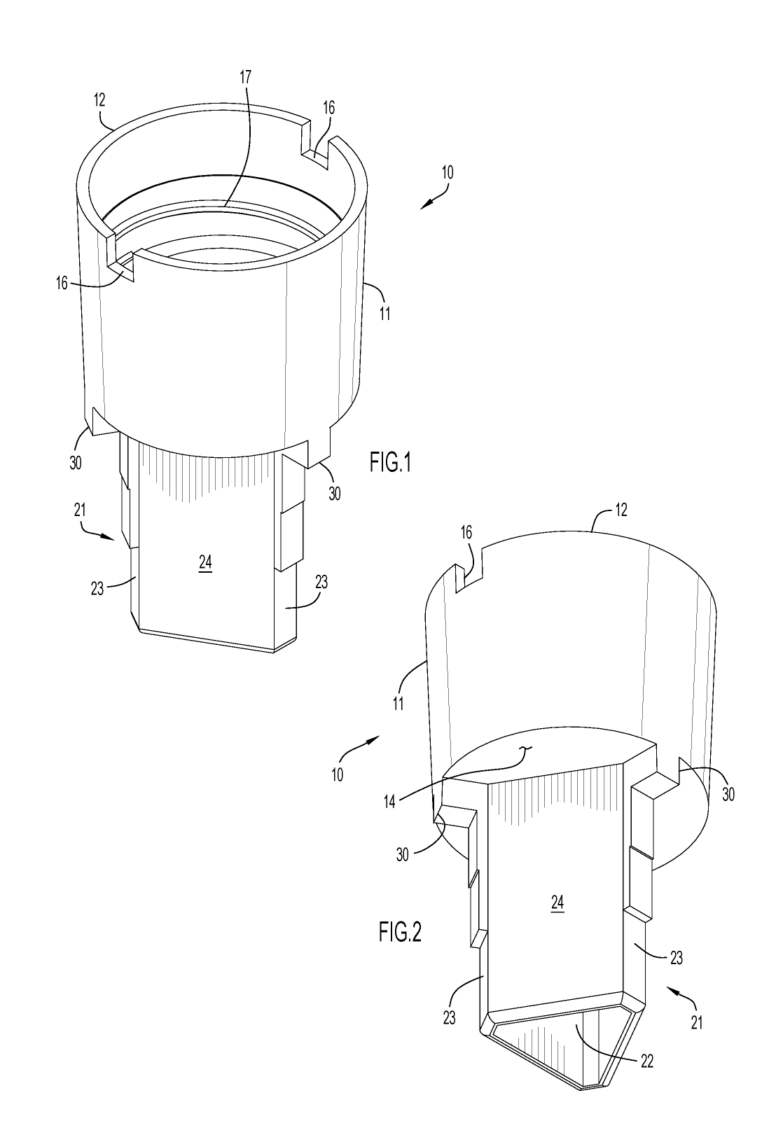

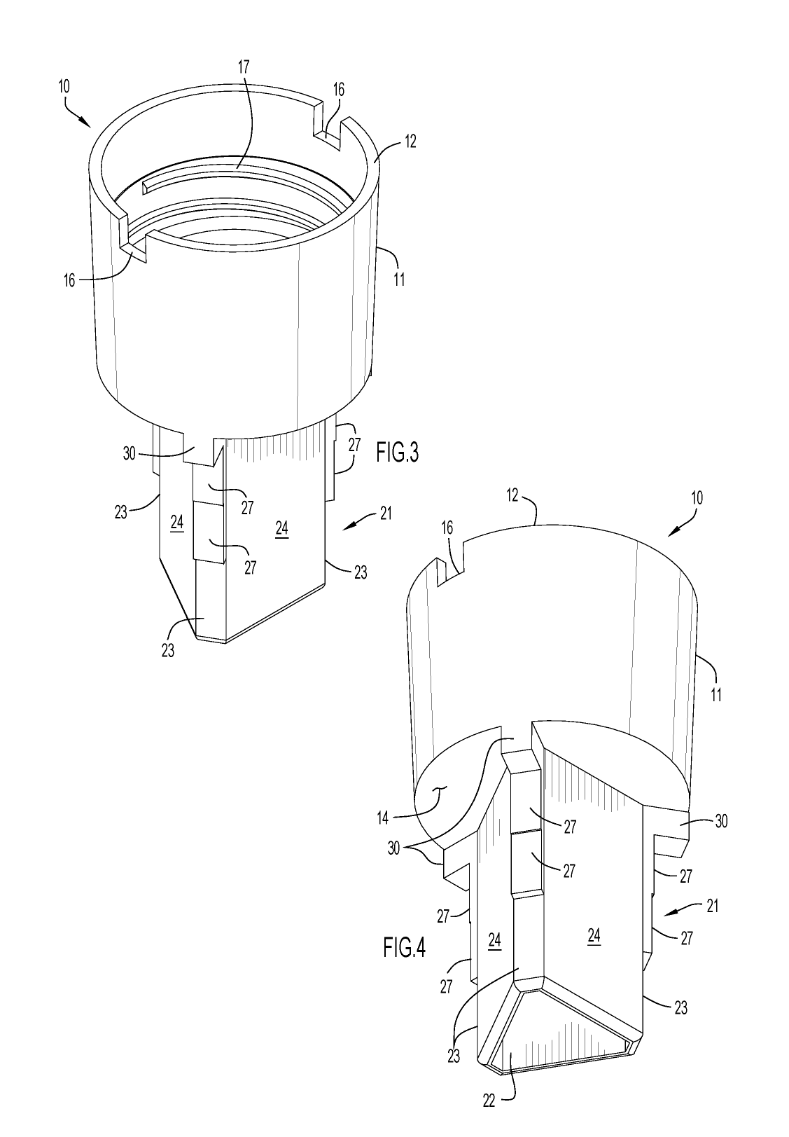

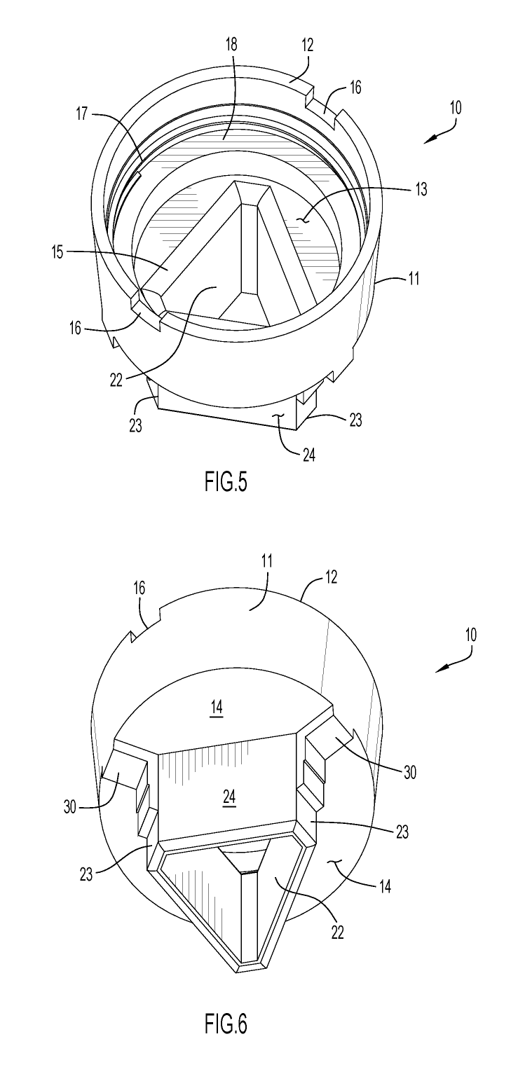

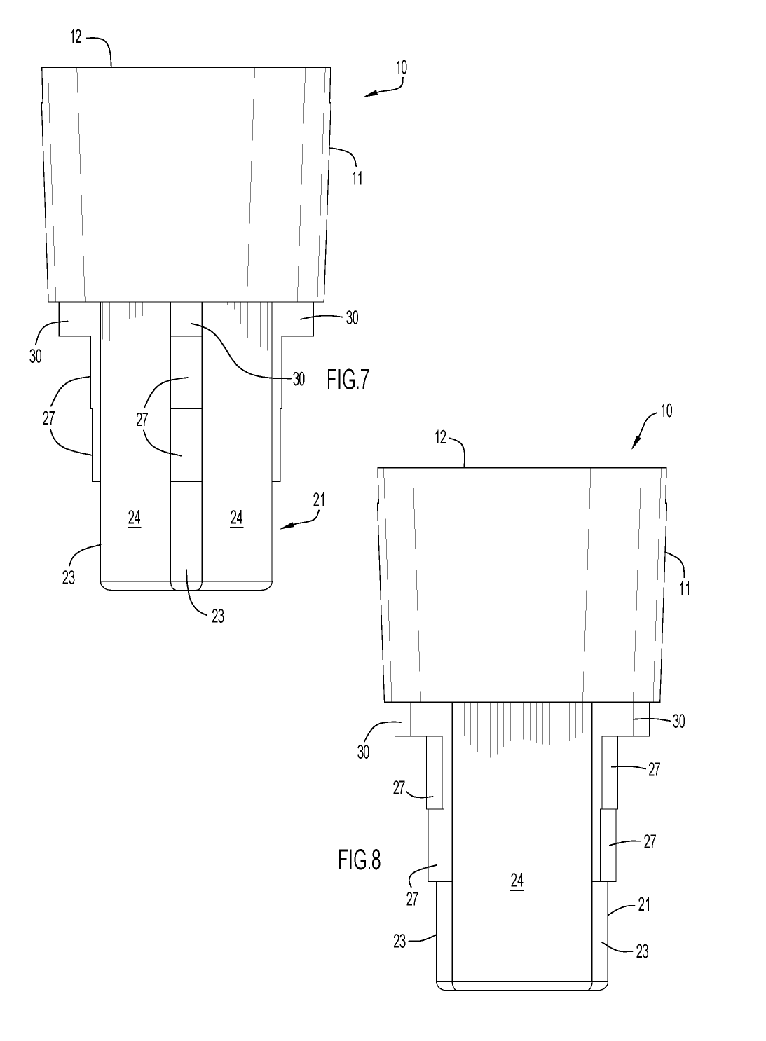

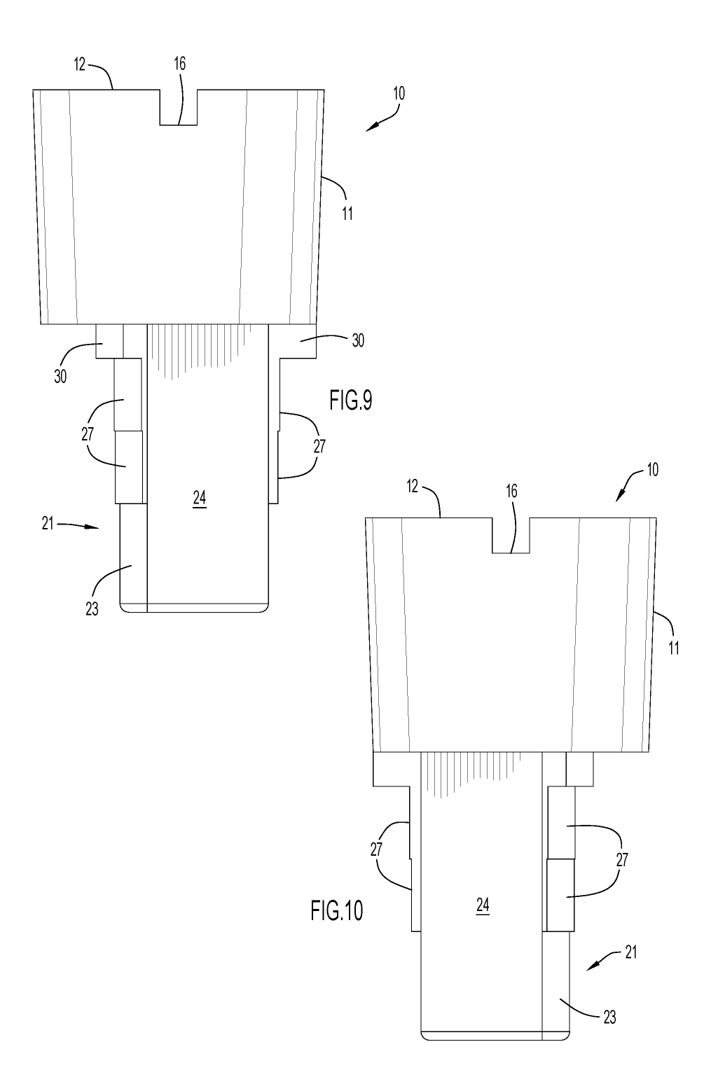

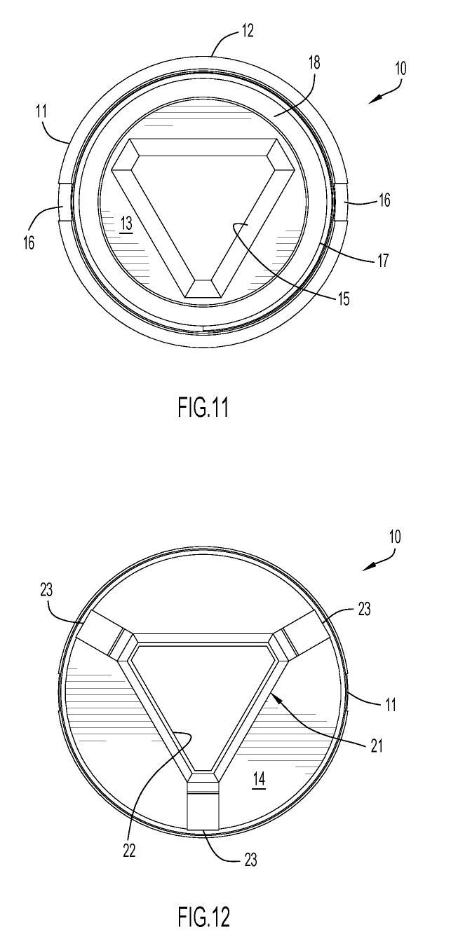

### DESCRIPTION OF THE PREFERRED EMBODIMENTS

Specific dimensions set forth below or incorporated herein by reference are by way of example for particular embodiments to assist in an understanding of the illustrated structure; these dimensions are not to be construed as limiting the scope of the invention.

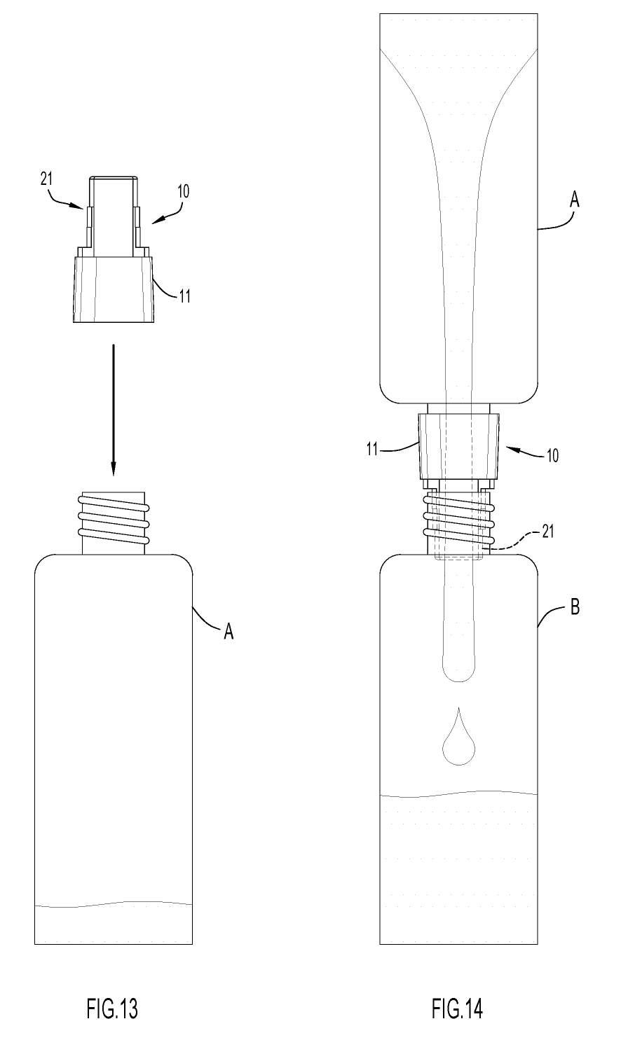

Referring more specifically to the accompanying drawings, a fluid transfer device 10 is configured for transferring fluid from one container A to another container B (see FIGS. 13 and 14), the containers being of the type having a narrow neck at their upper ends through which fluid flows in and out of the container. The fluid transfer device 10 comprises a hollow generally cylindrical upper section 11 and longitudinally adjacent lower section 21. Upper section 11 may have a generally cylindrical configuration including an open annular top edge 12 and a circular bottom wall having an upward facing interior surface 13, a downward facing exterior surface 14, and a flow transfer aperture 15 defined therethrough. In the disclosed embodiment flow transfer aperture 15 has a triangular shape. The interior cylindrical surface of upper section 11 is threaded at 17 to receive and engage the externally threaded cap-engaging necks of most cream and containers sold commercially, including container A to be emptied. The necks of some other commercially available bottles and containers for creams and lotions do not have exterior threads; to engage these necks the interior of upper section 11 is provided with a raised annular ledge 18 surrounding flow transfer aperture 15 and configured such that the bottle neck extends into the circular space surrounded by the ledge. Other bottle containers for creams and lotions do not have threaded necks but instead have thin locking flanges for engaging a cap; in order to engage such containers with lateral positional stability the top annular edge 12 in upper section 11 also has two diametrically opposed notches 16 defined therethrough with an angular width and longitudinal depth that closely fit those locking flanges.

The lower section 21 is a flow tube having a an exterior profile of polyhedral prism configuration which, in the disclosed embodiment, is a triangular prism having an internal longitudinal flow passage 22 symmetrically disposed about a longitudinal flow axis of the device with a triangular cross section that corresponds to and is in abutting alignment with the triangular flow transfer aperture 15 in the upper section along the longitudinal flow axis of passage 22. The exterior of the triangular prism is configured to fit into the neck of a receiving container B and includes three longitudinally extending edges 23 that are mutually angularly spaced by 120°. Edges 23 are located at the intersections of the three prism faces 24 configured as flat planar surfaces. Each edge 23 is configured with a downwardly extending series of radial projections 27 with radial thicknesses that decrease at downwardly successive locations. Two such projections are shown at each edge 23 in the illustrated embodiment, but it is understood that any number of such projections may be provided. The function of projections 27 is to assure that each edge 23 makes contact with the interior wall of the neck of the receiving container B irrespective of the different diameters of that neck in different commercially available cream and lotion containers. More broadly stated, the longitudinal edges 23 of the lower section 11 are provided with radial extension variations along their lengths to permit close fit contact within container necks of different sizes.

Three spacers 30 project downward from the downward facing exterior surface 14 of the upper section bottom wall. Each spacer 30 is angularly aligned with a respective edge 23 and its series of projections 27 and extends radially therefrom along surface 14 to the circumferential edge of that surface. The depth of each spacer (i.e., in a downward or axial dimension of the flow tube) is sufficient to provide a substantially annular air flow exhaust space between surface 14 the lip of a receiving bottle B when device 10 is in use.

When the flow tube of lower section 21 is longitudinally inserted into the neck of receiving bottle B, each face 24 of lower section 21 defines a longitudinally extending flow passage with its opposing section of the cylindrical bottle neck wall. The transverse cross section of those flow passages is a circular segment which is much wider and less restrictive than an annular passage section that would result if the lower section 21 were a circular cylinder defining a narrow annular flow space as in some prior flow transfer devices. The circular segment passages of the present invention conduct parallel air flows from the interior of container B to the annular air egress exhaust space along bottom surface 14 as viscous fluid flows down into container B from container A which is received and engaged in upper section 11. In other words, the flat faces 24 of the polyhedral lower section 11 define respective relatively wide parallel air flow passages with the opposing sections of the cylindrical neck of the bottle in which the lower section is received. These passages are in flow communication with the air flow exhaust space to permit relatively unrestricted egress of air from the container being filled.

As described above and shown in FIGS. 13 and 14, the hollow upper section 11 is configured to receive and positively engage a neck of an inverted first container A. The lower section 21 is configured to be received in a neck of an upright second container B with edges 23 of the polygonal exterior in contact with an interior wall of the neck of container B. The vertical spacers 30 may be configured to rest on a lip of the second container B that has received the lower section 21 to provide an air egress passage for air flowing out from container B along faces 24 of the polygonal exterior of the lower section flow tube.

The maximum diameter defined by an imaginary circle perpendicular to the flow axis at any point along the length of the lower section 21 and connecting the external edges 23 of the lower section 21 is smaller than the diameter of the exterior surface 14 of the upper section bottom wall. Otherwise stated, the upper section 11 is wider than said lower section 21. In addition, the diameter of that imaginary circle is sufficiently small to permit the lower section to fit at least part way through the neck of fluid receiving container B.

Summarizing the invention, a fluid transfer device includes an open upper section and a filling tube lower section. The upper section has a hollow generally cylindrical configuration adapted for receiving and engaging the neck or spout of an inverted supply bottle being emptied. It will be appreciated that the outer periphery of the upper section need not be cylindrical or of any specific configuration since that periphery provides no function in the operation of the device; however the bottom surface of the upper section must be wider than the lower section which depends therefrom. The lower section is in the form of a tube of triangular (or other regular or irregular polygonal) transverse cross-section configured to extend into a receiving bottle. When so extended the corner edges or apices of the tube exterior abut the interior wall of the receiving bottle along at least a portion of their lengths to provide at least three-point positional lateral stability of the device in the receiving bottle. Spacers, preferably located at the upper ends of the edges of the lower section, project downward from the upper section and may rest on the lip of the receiving bottle when the bottom section is maximally inserted into the receiving bottle. This assures that a vertical (i.e., axial) exhaust space is maintained between the bottom surface of the upper section and the lip of the receiving bottle during a filling operation.

Importantly, the three (or more) outer side surfaces or faces of the triangular (or other polygonal) prism tube are relatively widely spaced from the annular interior wall of the neck of the receiving bottle. This may be contrasted to the narrow annular space that would exist if the filling tube were a circular cylinder that contacts parts of the inner wall of the bottle neck to provide the necessary positional stability. These wider spaces between the tube sides and the bottle neck provide relatively unrestricted air flow egress passages having a wide transverse cross-section of circular segment configuration. Thus, displaced air escaping the receiving bottle flows through the wide spaces along the three outer faces of the lower section and up through the exhaust space above the receiving bottle to the ambient environment to permit the viscous filling fluid from the emptying bottle to flow from the upper section through the lower section and into the receiving bottle as gravitationally induced flow.

It will be appreciated that the configuration of the internal flow passage 22 need not be similar to the polyhedral exterior profile configuration of tube 21. For example, the flow passage 22 may be a circular cylinder even though the exterior profile configuration is polyhedral. Since it is preferable that the configuration of flow transfer aperture 15 match the flow passage inlet configuration, in this case the flow transfer aperture would preferably be circular.

The interior of the upper section has threading to engage the mouths of inverted bottles that are threaded, and an annular ridge to support or engage the mouths or necks of inverted bottles that have no external threads. Plural vertically spaced annular ridges of different diameters may be positioned at longitudinally spaced locations to accommodate inverted bottle necks of respectively different diameters. The three external edges or corners of the triangular prism lower section filling tube have spacer ridges or steps projecting therefrom to a different radial extent and at different longitudinal (i.e., axial) locations to permit the tube to engage the interior wall of different size bottle necks that are commonly found in the cream and lotion market. The fluid transfer device is thus configured to permit fluid transfer to be effected between bottle mouths of substantially any configuration.

It will be appreciated from the foregoing that the fluid transfer device of the present invention includes the following features: (a) it provides sufficiently wide air flow passages so as to not restrict the flow of air being displaced by fluid being transferred into the receiving bottle; (b) it accommodates transferring and receiving bottles having necks of different sizes and configuration; and (c) it provides positive engagement with positional stability for both the transferring and receiving containers during a fluid transfer procedure.

Having described preferred embodiments of new and improved methods and apparatus for transferring viscous fluids, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

I claim:

1. A fluid transfer device comprising:
a hollow upper section including:
an open top end; and
a bottom wall having an upward facing interior surface, a downward facing exterior surface, and a flow transfer aperture defined therethrough; and
a lower flow tube section having an exterior profile in the form of a polyhedral prism extending longitudinally downward from said downward facing exterior surface of said bottom wall, said flow tube having a flow passage extending longitudinally therethrough along a longitudinal flow axis of the tube;
wherein said flow transfer aperture is in flow communication and aligned with said flow passage along said longitudinal flow axis.

2. The fluid transfer device of claim 1 wherein said polyhedral prism is a triangular prism having three longitudinally extending edges defining its transverse periphery, and further comprising a plurality of vertical spacers each extending radially outward along said downward facing surface from a respective prism edge.

3. The fluid transfer device of claim 2 wherein each of said edges is configured with a series of radial projections with radial thicknesses that decrease in downwardly successive locations.

4. The fluid transfer device of claim 3 wherein upper section has a threaded annular interior wall.

5. The fluid transfer device of claim 4 wherein said annular interior wall further includes at least one annular ridge disposed substantially concentrically about the longitudinal flow axis.

6. The fluid transfer device of claim 5 wherein said annular wall has an annular upper edge, said device further comprising at least first and second notches defined in in said annular upper edge at diametrically opposed locations.

7. The fluid transfer device of claim 2 wherein said upper section has a threaded annular interior wall.

8. The fluid transfer device of claim 7 wherein said annular wall has an annular upper edge having at least first and second notches defined therein at diametrically opposed locations.

9. The fluid transfer device of claim 8 wherein said interior annular wall includes at least one annular ridge projecting radially inward and disposed substantially concentrically about the longitudinal flow axis.

10. The fluid transfer device of claim 1 configured for transferring fluid between containers of the type having a narrow upper end neck through which fluid flows in and out of the container, said device further comprising:
said upper section being configured to receive and engage a neck of a first container to be emptied of fluid in an inverted orientation;
said lower section being configured to be received and engaged in a neck of a second container to receive fluid from the first container; and
at least one spacer projecting downward from said downward facing surface at a location radially outward from said lower section, said spacer configured to provide an air flow exhaust space between said downward facing surface and an upper lip end of the neck of the second container when both containers are received and engaged by the device.

11. The fluid transfer device of claim 10:
wherein said polyhedral prism has a plurality of longitudinally extending edges defining its transverse periphery, said edges being configured such that each edge contacts a respective location interiorly of the neck of the second container when both containers are received and engaged by the device; and
wherein said polyhedral prism has a plurality of faces, each defining spaced from a respective section of the interior wall of the neck of the second container to define respective air flow passage segment for conducting air from the second container to the air flow exhaust space.

12. The fluid transfer device of claim 11 wherein each of said edges is configured with a downwardly extending series of radial projections with radial thicknesses that decrease at downwardly successive locations.

13. The fluid transfer device of claim 12 wherein said upper section has a threaded annular interior wall and an annular upper edge having at least first and second notches defined therein at diametrically opposed locations.

14. A method for transferring fluid between containers of the type having a narrow upper end neck through which fluid flows in and out of the container, said method using device of claim 1 and comprising:
receiving and engaging in said upper section a neck of a first container to be emptied of fluid in an inverted orientation;
receiving and engaging said lower section in a neck of a second container to receive fluid from the first container, wherein the neck of the second container is in contact with angularly spaced longitudinally extending edges of said lower section;
providing an air flow exhaust path between said downward facing surface and an upper lip end of the neck of the second container when both containers are received and engaged by the device; and
providing a plurality of air passages from the interior of the second container to the air flow exhaust path, said air flow passages each being configured with a circular segment cross-section defined between a respective face of said polyhedral prism and a respective section of the neck of the second container facing and spaced from that space.

15. The method of claim 14 wherein receiving and engaging said upper section includes providing at least three different modes of engagement to permit engagement of three respective different container neck configurations

16. The method of claim 15 wherein receiving and engaging the lower section includes providing variations in radial dimension along the lengths of edges of the polyhedral prism to permit contact between all of the edges and the interior wall of the different size necks of the second container.

17. A fluid transfer device for transferring fluid from one container to another container of the type having a narrow neck at its upper end through which fluid flows in and out of the container, said device comprising:
a hollow upper section including:
an open top end; and
a bottom wall having an upward facing interior surface, a downward facing exterior surface, and a flow transfer aperture defined therethrough;
a lower section comprising a flow tube having a polygonal exterior in transverse cross-section, and an interior longitudinally extending flow passage disposed about a longitudinal axis of the fluid transfer device, said flow passage positioned in vertical adjacency and longitudinal alignment with said flow transfer aperture;
wherein said upper section has a wider transverse cross section than said lower section; and further comprising
a vertical spacer projecting downward from the downward facing exterior surface of the upper section bottom wall.

18. The fluid transfer device of claim 17:
wherein the hollow upper section is configured to receive and positively engage a neck of an inverted first container; and
wherein the lower section is configured to be received in a neck of an upright second container with apices of said polygonal exterior in contact with an interior wall of the neck of the second container.

19. The fluid transfer device of claim 2 wherein said vertical spacer is configured to rest on a lip of the second container received in the lower section to provide an air egress passage for air flowing out from the second container along sides of the polygonal exterior of said lower section flow tube.

20. The fluid transfer device of claim 3 wherein said polyhedral prism exterior profile is triangular.
